(19) United States
(12) Patent Application Publication
(10) Pub. No.: US 2022/0360568 A1
(43) Pub. Date: Nov. 10, 2022

(54) PROTECTING REAL-TIME AUDIO/VISUAL COMMUNICATIONS END-TO-END

(71) Applicant: Facebook Technologies, LLC, Menlo Park, CA (US)

(72) Inventor: Gaurav Arora, Cupertino, CA (US)

(21) Appl. No.: 17/733,632

(22) Filed: Apr. 29, 2022

Related U.S. Application Data
(60) Provisional application No. 63/183,923, filed on May 4, 2021.

(51) Int. Cl. H04L 9/40; H04L 65/80

(52) U.S. Cl. CPC H04L 63/0428; H04L 65/80; H04L 63/068

(57) ABSTRACT

Methods, systems, and storage media for protecting real-time audio/visual (A/V) communications are disclosed. Exemplary implementations may: capture, at a sensor of a first A/V communication device, A/V data; transmit the captured data to a secure hardware module of a System-on-a-Chip (SoC) associated with the first A/V communication device, the secure hardware module having a first trusted execution environment (TEE) that is inaccessible by an Operating System (OS) of the SoC associated with the first A/V communication device; encrypt, in the first TEE, the captured data; transmit the encrypted data from the first A/V communication device to a second A/V communication device; receive, at a secure hardware module of a SoC associated with the second A/V communication device, the encrypted data, the secure hardware module of the SoC associated with the second A/V communication device having a second TEE that is inaccessible by an OS of the SoC associated with the second A/V communication device; decrypt, in the second TEE, the encrypted data; and cause presentation of the decrypted data at the second A/V communication device.

### CROSS-REFERENCE TO RELATED APPLICATIONS

This present application claims the benefit of priority under 35 U.S.C. § 119(e) to U.S. Provisional Patent Application No. 63/183,923, filed May 4, 2021, the disclosure of which is hereby incorporated by reference in its entirety for all purposes.

### TECHNICAL FIELD

The present disclosure generally relates to protecting real-time audio/visual (A/V) communications. More particularly, the present disclosure relates to protecting real-time A/V communications from end-to-end, that is, from data-capture on a first A/V communication device to presentation of the captured data on one or more second A/V communication devices.

### BACKGROUND

Audio/visual (A/V) communication devices are prevalently used both for personal and professional use. Despite their prevalence, however, wide-spread reluctance exists among users concerning the security and/or privacy of the data being streamed among A/V communication devices. For instance, it would be undesirable if an A/V communication device were to autonomously initiate an A/V communication (i.e., a call) without knowledge of the user or if a malicious actor were to remotely penetrate (e.g., hack) into an A/V communication device and attempt to stream audio, images and/or video of unsuspecting users. (As used herein, the terms “audio/visual” or “A/V” refers to any or all of audio, image, or video data or communication devices.)

Some A/V communication device suppliers offer what is referred to in the art as “end-to-end encryption.” As used by such suppliers, the term has traditionally referred to data being transmitted from one end-point device (e.g., a first A/V device) to another end-point device (e.g., a second A/V device) being encrypted while the data is in transit. This, however, isn't truly “end-to-end,” as it does not provide any kind of protection while the data is within an A/V communication device. For instance, a hacker may penetrate into the Operating System (“OS”) of an A/V communication device and access the data and/or download malicious software designed to siphon the data before the data is in transit between A/V communication devices.

### BRIEF SUMMARY

The subject disclosure provides for systems and methods for protecting real-time audio/visual (A/V) communications from data-capture on a first A/V communication device (e.g., utilizing the first A/V communication device's camera, microphone, or the like) to presentation of the captured data on a second A/V communication device (e.g., utilizing the second A/V communication device's display, speakers, or the like).

One aspect of the present disclosure relates to a method for protecting real-time audio/visual (A/V) communications. The method may include capturing, at a sensor of a first A/V communication device, A/V data. The method may include transmitting the captured A/V data to a secure hardware module of a System-on-a-Chip (SoC) associated with the first A/V communication device, the secure hardware module having a first trusted execution environment that is inaccessible by an Operating System of the SoC associated with the first A/V communication device. The method also may include encrypting, in the first trusted execution environment, the captured data. The method further may include transmitting the encrypted data from the first A/V device to one or more second A/V devices. The method also may include receiving, at a secure hardware module of a SoC associated with the second A/V communication device(s), the encrypted data, the secure hardware module of the SoC associated with the second A/V communication device(s) having a second trusted execution environment that is inaccessible by an Operating System (OS) of the SoC associated with the second A/V communication device(s). The method also may include decrypting, in the second trusted execution environment, the encrypted data. The method also may include causing presentation of the decrypted data at the second A/V communication device(s).

Another aspect of the present disclosure relates to a system configured for protecting real-time audio/visual communications. The system may include one or more hardware processors (or hardware accelerators) configured by machine-readable instructions and memory that can be partitioned as secure and non-secure modules. The data may stay within secure memory and be operated upon only by secure hardware processors/accelerators while it is in secure memory. The processor(s) may be configured to capture, at a sensor of a first A/V communication device, A/V data. The processor(s) may be configured to transmit the captured A/V data to a secure hardware module of a SoC associated with the first A/V communication device, the secure hardware module having a first trusted execution environment that is inaccessible by an OS of the SoC associated with the first A/V communication device. The processor(s) may be configured to encrypt, in the first trusted execution environment, the captured data using a session key. The processor(s) may be configured to transmit the encrypted data from the first A/V device to one or more second A/V devices. The processor(s) may be configured to receive, at a secure hardware module of a SoC associated with the second A/V communication device(s), the encrypted data, the secure hardware module of the SoC associated with the second A/V communication device(s) having a second trusted execution environment that is inaccessible by an OS of the SoC associated with the second audio/visual communication device(s). The processor(s) may be configured to decrypt, in the second trusted execution environment, the encrypted data. The processor(s) may be configured to cause presentation of the decrypted data at the second A/V communication device(s). The data may remain inside the second trusted execution environment until it is rendered as visual pixels on a display or as audio output from one or more speakers of the second A/V communication device(s).

Yet another aspect of the present disclosure relates to a non-transient computer-readable storage medium having instructions embodied thereon, the instructions being executable by one or more processors to perform a method for protecting A/V communications. The method may include capturing, at a sensor of a first A/V communication device, real-time A/V data. The method may include transmitting the captured real-time A/V data to a secure hardware module of a SoC associated with the first A/V communication device, the secure hardware module having a first trusted execution environment that is inaccessible by an OS of the SoC associated with the first A/V communication device. The method also may include encrypting, in the first trusted execution environment, the captured data. The method further may include transmitting the encrypted data from the first A/V device to one or more second A/V device(s). The method also may include receiving, at a secure hardware module of a SoC associated with the second A/V communication device(s), the encrypted data, the secure hardware module of the SoC associated with the second A/V communication device(s) having a second trusted execution environment that is inaccessible by an OS of the SoC associated with the second A/V communication device(s). The method also may include decrypting, in the second trusted execution environment, the encrypted data. The method also may include causing presentation of the decrypted data at the second A/V communication device(s).

Still another aspect of the present disclosure relates to a system configured for protecting real-time A/V communications. The system may include means for capturing, at a sensor of a first A/V communication device, A/V data. The system may include means for transmitting the captured A/V data to a secure hardware module of a System-on-a-Chip (SoC) associated with the first A/V communication device, the secure hardware module having a first trusted execution environment that is inaccessible by an Operating System of the SoC associated with the first A/V communication device. The system may include means for encrypting, in the first trusted execution environment, the captured data. The system may include means for transmitting the encrypted data from the first A/V device to one or more second A/V devices. The system may include means for receiving, at a secure hardware module of a SoC associated with the second A/V communication device(s), the encrypted data, the secure hardware module of the SoC associated with the second A/V communication device(s) having a second trusted execution environment that is inaccessible by an Operating System (OS) of the SoC associated with the second A/V communication device(s). The system may include means for decrypting, in the second trusted execution environment, the encrypted data. The system may include means for causing presentation of the decrypted data at the second A/V communication device(s).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system configured for protecting real-time audio/visual (A/V) communications, in accordance with one or more implementations

FIG. 2 illustrates an example flow diagram for protecting real-time audio/visual (A/V) communications, according to certain aspects of the disclosure.

FIG. 3 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Audio/visual (A/V) communication devices are prevalently used both for personal and professional use. Despite their prevalence, however, wide-spread reluctance exists among users concerning the security and/or privacy of the data being streamed among A/V communication devices. For instance, it would be undesirable if an A/V communication device were to autonomously initiate an A/V communication (i.e., a call) without knowledge of the user or if a malicious actor were to remotely penetrate (e.g., hack) into an A/V communication device and attempt to stream audio, images and/or video of unsuspecting users.

Some A/V device suppliers offer what is referred to in the art as “end-to-end encryption.” As used by such suppliers, the term has traditionally referred to data being transmitted from one end-point device (e.g., a first A/V communication device) to another end-point device (e.g., a second A/V communication device) being encrypted while the data is in transit. This, however, isn't truly “end-to-end,” as it does not provide any kind of protection while the data is within an A/V communication device. For instance, a hacker may penetrate into the Operating System (“OS”) of an A/V communication device and access the data and/or download malicious software designed to siphon the data before the data is in transit between A/V communication devices.

Embodiments of the disclosure described herein provide a Platform-level security enhancement capable of protecting the data flow inside a first end-point A/V communication device such that only encrypted call data (i.e., encrypted A/V data) is submitted to an application running on the Central Processing Unit (“CPU”) for streaming to another end-point A/V communication device(s) engaged in the call. With this added security, the aim is to avoid having a mechanical camera shutter (close/open shutter state is autonomously determined by the hardware) in A/V communication devices so that the user can feel confident that the camera/voice streams will not be streamed without their consent (even if the mechanical camera shutter is open). The removal of this shutter can result in a cost saving in the A/V communication device itself and it avoids the extra step of opening the shutter (or ensuring it is open) when a user wants to make an A/V call.

Embodiments of the present disclosure provide protection of data flows within A/V communication device hardware and create/exchange video “calling session keys” for encrypting A/V data streams.

In one embodiment, upon boot-up, the hardware (i.e., the A/V communication device) may set the privilege level for all the hardware modules inside a SoC that can read/write captured (or decoded) image/video/audio stream buffers (e.g., from Sensor, ISP, DeWarp Unit, AI Processing Unit (APU), GPU to Video/Audio Encoder Pipeline and Audio Render Pipeline for the downstream channel). If a privilege level is set as “secure,” the drivers of that secure hardware module may run inside a Trusted Execution Environment (TEE) of the SoC (e.g., ARM TrustZone) and are protected from Open OSs (e.g., Linux/Android) and hence are protected from malicious hack attacks trying to get to the streaming data buffers. If a privilege level is set a “non-secure,” the drivers of the non-secure hardware module may run outside of the TEE of the SoC.

In some embodiments, A/V calling applications (e.g. WHATSAPP, ROOMS, MESSENGER, ZOOM, BLUEJEANS, WEBEX, etc.) may allocate memory pools in secure memory. Secure Memory is a carve-out partition of system memory which can only be read/written from hardware modules having a “secure” setting, and also from TEE kernel and driver software.

After the A/V data has gone through the entire processing pipeline inside the SoC and the buffers have been compressed into a bitstream and are ready for transmission to the remote callers in the call, these buffers may be bulk-encrypted with a “calling session key” and exported out to non-secure memory where the calling application can stream them out of the A/V communication device.

The receiving devices may be configured to engage in bulk-decryption in a TEE associated with a SoC of the receiving devices to avoid any “in-the-clear” data and then use the “secure” video decoder, GPU and display to decode and render video on the display (and/or present audio data through a speaker or the like). This ensures protection in an end-to-end fashion from the image/voice sensor in the broadcasting device to display/presentation on the receiving device.

During “video calling session” initialization, the master device (i.e., the device being used by the meeting host) may generate symmetric “calling session keys” and using asymmetric keys that are shared early on in the initialization flow, the symmetric “calling session keys” may be shared among the calling participants. In embodiments, the “calling session keys” may be rotated every few seconds, i.e., a new odd/even key pair is generated by the master device and sent to all the participants and each buffer when streamed out has a bit in the header to indicate which key (odd or even) was used for encryption. In embodiments, the “calling session keys” may be rotated every 1-10 seconds. In embodiments, the “calling session keys” may be rotated every 1-20 seconds.

This approach can be implemented in current generation SoCs to increase the end-to-end protection and, hence, privacy for people using the video calling services with a bit of modifications done to the driver and application frameworks. This approach could also support the case where an application may need a low resolution/low frame rate copy of the streams because the TEE software can put in a policy (this restrictive policy cannot be modified without having access to the source code of the Trusted App and ability to circumvent secure boot in the device) to share such decimated stream which may not be useful to hackers but could help with some UI/UX use-cases.

Embodiment hereof provide a security island for all the data parts inside the SoC chip and the memory so that the entire data processing runs in the secure firewall and all the data are never available to the CPU where malicious software may have been planted via a remote exploit and may be running. This secure firewall provides a hardware-anchored security which is more impenetrable than software containerization and access control schemes which are offered by SELinux or Linux containers. Embodiments create secure channels on the hardware itself within the chip and the memory, on which the data is kept while it's on a A/V communication device and encrypted before that data is sent into a non-secure memory, which is used for transmitting the data to the other party. Sensor-to-display end-to-end protection is created from the point an image is captured at the camera sensor, to the time it gets consumed on a display of the other party, utilizing a secure tunnel.

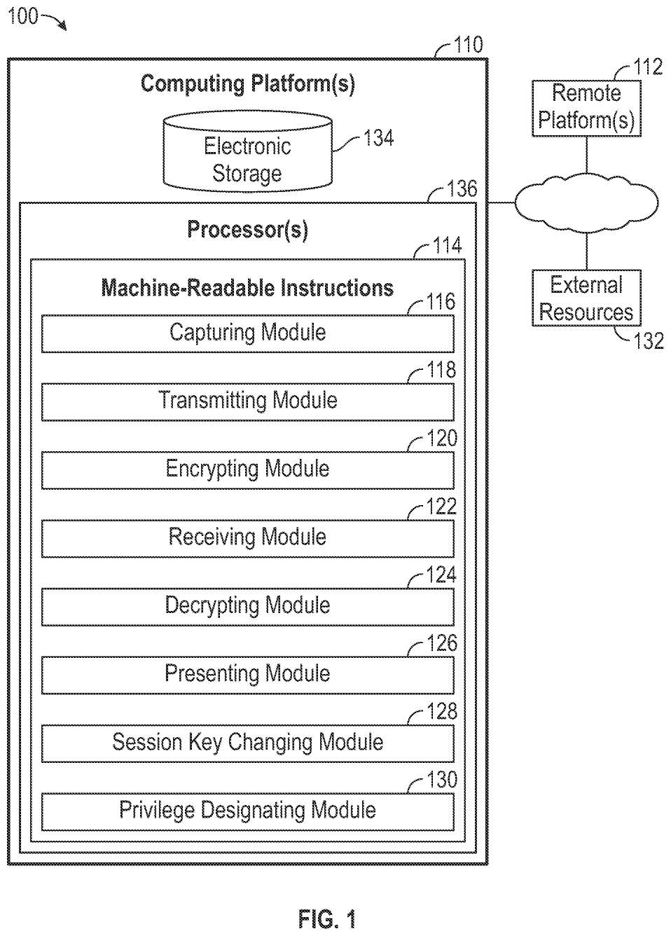

FIG. 1 illustrates a system 100 configured for protecting real-time audio/visual (A/V) communications, according to certain aspects of the disclosure. In some implementations, system 100 may include one or more computing platforms 110. Computing platform(s) 110 may be configured to communicate with one or more remote platforms 112 according to a client/server architecture, a peer-to-peer architecture, and/or other architectures. Remote platform(s) 112 may be configured to communicate with other remote platforms via computing platform(s) 110 and/or according to a client/server architecture, a peer-to-peer architecture, and/or other architectures. Users may access system 100 via remote platform(s) 112.

Computing platform(s) 110 may be configured by machine-readable instructions 114. Machine-readable instructions 114 may include one or more instruction modules. The instruction modules may include computer program modules. The instruction modules may include one or more of capturing module 116, transmitting module 118, encrypting module 120, receiving module 122, decrypting module 124, presenting module 126, session key changing module 128, privilege designating module 130, and/or other instruction modules.

Capturing module 116 may be configured to capture A/V data. In aspects, capturing module 116 may be configured to capture A/V data at a sensor of a first A/V communication device.

Transmitting module 118 may be configured to transmit captured A/V data to a secure hardware module of a System-on-a-Chip (SoC) associated with a first A/V communication device. In aspects, the secure hardware module may have a first trusted execution environment that is inaccessible by an Operating System of the SoC associated with the first A/V communication device.

Encrypting module 120 may be configured to encrypt captured A/V data. In aspects, encrypting module 120 may be configured to encrypt captured A/V data in a first trusted execution environment (e.g., a first trusted execution environment of a secure hardware module of a SoC associated with a first A/V communication device). In aspects, encrypting module 120 may be configured to encrypt captured data with a session key.

Transmitting module 122 may be configured to transmit encrypted data from the first A/V communication device to a second A/V communication device.

Receiving module 124 may be configured to receive encrypted data. In aspects, receiving module 124 may be configured to receive encrypted data at a secure hardware module of a SoC associated with a second A/V communication device. In aspects, the secure hardware module of the SoC associated with the second A/V communication device may have a second trusted execution environment that is inaccessible by an Operating System of the SoC associated with the second A/V communication device.

Decrypting module 126 may be configured to decrypt encrypted data. In aspects, decrypting module 126 may be configured to decrypt encrypted data in a second trusted execution environment (e.g., a second trusted execution environment of a secure hardware module of an SoC associated with a second A/V communication device). In aspects, the data may remain inside the second trusted execution environment until it is rendered as visual pixels on a display or as audio output from one or more speakers of the second A/V communication device.

Presenting module 128 may be configured to cause presentation of decrypted data. In aspects, presenting module 128 may be configured to cause presentation of decrypted data at a second A/V communication device.

Session key changing module 128 may be configured to change a session key utilized for encrypting captured data. In aspects, session key changing module 128 may be configured to periodically change a session key in accordance with a pre-determined time interval. In aspects, a pre-determined time interval may be a few seconds. In aspects, a pre-determined time interval may be 1-10 seconds. In aspects, a pre-determined time interval may be 1-20 seconds.

Privilege designating module 130 may be configured to designate a privilege level of one or more hardware modules of an SoC associated with an A/V device as one of secure or non-secure. In aspects, privilege designating module 130 may be configured to designate a privilege level of at least a portion of a plurality of hardware modules of an SoC associated with a first A/V device as one of secure or non-secure. Privilege designating module 130 further may be configured to designate a privilege level of at least a portion of a plurality of hardware modules of the SoC associated with a second A/V device as one or secure or non-secure.

In some implementations, computing platform(s) 110, remote platform(s) 112, and/or external resources 132 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 110, remote platform(s) 112, and/or external resources 132 may be operatively linked via some other communication media.

A given remote platform 112 may include one or more processors configured to execute computer program modules. The computer program modules may be configured to enable an expert or user associated with the given remote platform 112 to interface with system 100 and/or external resources 132, and/or provide other functionality attributed herein to remote platform(s) 112. By way of non-limiting example, a given remote platform 112 and/or a given computing platform 110 may include one or more of a server, a desktop computer, a laptop computer, a handheld computer, a tablet computing platform, a NetBook, a Smartphone, a gaming console, and/or other computing platforms.

External resources 132 may include sources of information outside of system 100, external entities participating with system 100, and/or other resources. In some implementations, some or all of the functionality attributed herein to external resources 132 may be provided by resources included in system 100.

Computing platform(s) 110 may include electronic storage 134, one or more processors 126, and/or other components. Computing platform(s) 110 may include communication lines, or ports to enable the exchange of information with a network and/or other computing platforms. Illustration of computing platform(s) 110 in FIG. 1 is not intended to be limiting. Computing platform(s) 110 may include a plurality of hardware, software, and/or firmware components operating together to provide the functionality attributed herein to computing platform(s) 110. For example, computing platform(s) 110 may be implemented by a cloud of computing platforms operating together as computing platform(s) 110.

Electronic storage 134 may comprise non-transitory storage media that electronically stores information. The electronic storage media of electronic storage 134 may include one or both of system storage that is provided integrally (i.e., substantially non-removable) with computing platform(s) 110 and/or removable storage that is removably connectable to computing platform(s) 110 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 136, information received from computing platform(s) 110, information received from remote platform(s) 112, and/or other information that enables computing platform(s) 110 to function as described herein.

Processor(s) 136 may be configured to provide information processing capabilities in computing platform(s) 110. As such, processor(s) 136 may include one or more of a digital processor, an analog processor, a digital circuit designed to process information, an analog circuit designed to process information, a state machine, and/or other mechanisms for electronically processing information. Although processor(s) 136 is shown in FIG. 1 as a single entity, this is for illustrative purposes only. In some implementations, processor(s) 136 may include a plurality of processing units. These processing units may be physically located within the same device, or processor(s) 136 may represent processing functionality of a plurality of devices operating in coordination. Processor(s) 136 may be configured to execute modules 116, 118, 120, 122, 124, 126, 128. and/or 130, and/or other modules. Processor(s) 136 may be configured to execute modules 116, 118, 120, 122, 124, 126, 128. and/or 130, and/or other modules by software; hardware; firmware; some combination of software, hardware, and/or firmware; and/or other mechanisms for configuring processing capabilities on processor(s) 136. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 116, 118, 120, 122, 124, 126, 128. and/or 130 are illustrated in FIG. 1 as being implemented within a single processing unit, in implementations in which processor(s) 136 includes multiple processing units, one or more of modules 116, 118, 120, 122, 124, 126, 128. and/or 130 may be implemented remotely from the other modules. The description of the functionality provided by the different modules 116, 118, 120, 122, 124, 126, 128. and/or 130 described below is for illustrative purposes, and is not intended to be limiting, as any of modules 116, 118, 120, 122, 124, 126, 128. and/or 130 may provide more or less functionality than is described. For example, one or more of modules 116, 118, 120, 122, 124, 126, 128. and/or 130 may be eliminated, and some or all of its functionality may be provided by other ones of modules 116, 118, 120, 122, 124, 126, 128. and/or 130. As another example, processor(s) 136 may be configured to execute one or more additional modules that may perform some or all of the functionality attributed below to one of modules 116, 118, 120, 122, 124, 126, 128. and/or 130.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

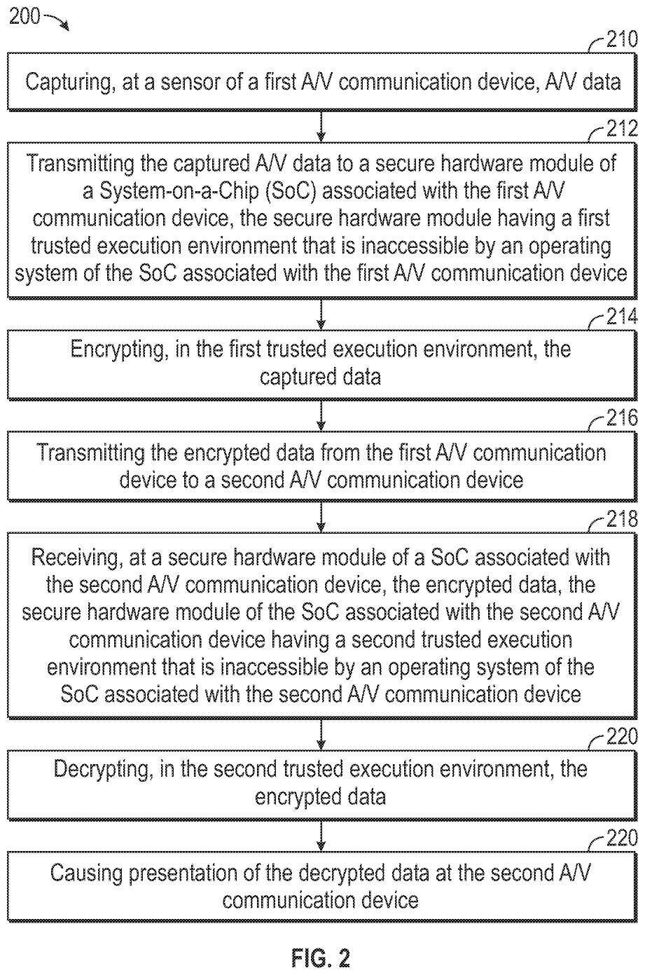

FIG. 2 illustrates an example flow diagram (e.g., process 200) for protecting real-time audio/visual (A/V) communications, according to certain aspects of the disclosure. For explanatory purposes, the exemplary process 200 is described herein with reference to FIG. 1. Further for explanatory purposes, the steps of the exemplary process 200 are described herein as occurring in serial, or linearly. However, multiple instances of the exemplary process 200 may occur in parallel.

At step 210, the process 200 may include capturing, at a sensor of a first A/V communication device, A/V data. In aspects, the A/V data may include one or more of audio data, image data, and video data.

At step 212, the process 200 may include transmitting the captured A/V data to a secure hardware module of a System on a Chip (SoC) associated with the first A/V communication device. In aspects, the secure hardware module may have a first trusted execution environment that is inaccessible by an Operating System of the SoC associated with the first A/V communication device.

At step 214, the process 200 may include encrypting, in the first trusted execution environment, the captured data. In aspects, encrypting the captured data may include encrypting the captured data with a session key. In aspects, the session key may be changed every few seconds (e.g., every 1-10 seconds).

At step 216, the process 200 may include transmitting the encrypted data from the first A/V communication device to a second A/V communication device.

At step 218, the process 200 may include receiving, at a secure hardware module of a SoC associated with the second A/V communication device, the encrypted data. In aspects, the secure hardware module of the SoC associated with the second A/V communication device may have a second trusted execution environment that is inaccessible by an Operating System of the SoC associated with the second A/V communication device.

At step 220, the process 200 may include decrypting, in the second trusted execution environment, the encrypted data.

At step 222, the process 200 may include causing presentation of the decrypted data at the second A/V communication device.

For example, as described above in relation to FIG. 1, at step 210, the process 200 may include capturing, at a sensor of a first A/V communication device, A/V data (e.g., through capturing module 116 of the system 100 of FIG. 1). At step 212, the process 200 may include transmitting the captured A/V data to a secure hardware module of a System on a Chip (SoC) associated with the first A/V communication device (e.g., through transmitting module 118 of the system of FIG. 1). In aspects, the secure hardware module may have a first trusted execution environment that is inaccessible by an Operating System of the SoC associated with the first A/V communication device. At step 214, the process 200 may include encrypting, in the first trusted execution environment, the captured data (e.g., through encrypting module 120 of the system 100 of FIG. 1). At step 216, the process 200 may include transmitting the encrypted data from the first A/V communication device to a second A/V communication device (e.g., through transmitting module 118 of the system 100 of FIG. 1). At step 218, the process 200 may include receiving, at a secure hardware module of a SoC associated with the second A/V communication device, the encrypted data (e.g., through receiving module 122 of the system 100 of FIG. 1). In aspects, the secure hardware module of the SoC associated with the second A/V communication device may have a second trusted execution environment that is inaccessible by an Operating System of the SoC associated with the second A/V communication device. At step 220, the process 200 may include decrypting, in the second trusted execution environment, the encrypted data (e.g., through decrypting module 124 of the process 200 of FIG. 2). At step 222, the process 200 may include causing presentation of the decrypted data at the second A/V communication device (e.g., through presenting module 126 of the system 100 of FIG. 1).

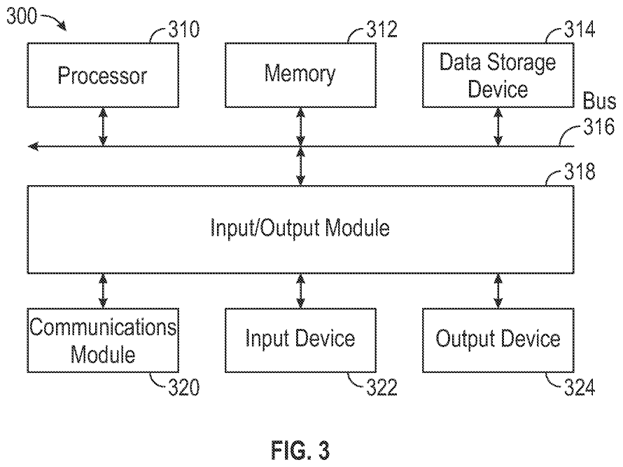

FIG. 3 is a block diagram illustrating an exemplary computer system 300 with which aspects of the subject technology can be implemented. In certain aspects, the computer system 300 may be implemented using hardware or a combination of software and hardware, either in a dedicated server, integrated into another entity, or distributed across multiple entities.

Computer system 300 (e.g., server and/or client) includes a bus 316 or other communication mechanism for communicating information, and a processor 310 coupled with bus 316 for processing information. By way of example, the computer system 300 may be implemented with one or more processors 310. Processor 310 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 300 can include, in addition to hardware, code that creates an execution environment for the computer program in question, e.g., code that constitutes processor firmware, a protocol stack, a database management system, an operating system, or a combination of one or more of them stored in an included memory 312, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 316 for storing information and instructions to be executed by processor 310. The processor 310 and the memory 312 can be supplemented by, or incorporated in, special purpose logic circuitry.

The instructions may be stored in the memory 312 and implemented in one or more computer program products, i.e., one or more modules of computer program instructions encoded on a computer readable medium for execution by, or to control the operation of, the computer system 300, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 312 may also be used for storing temporary variable or other intermediate information during execution of instructions to be executed by processor 310.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 300 further includes a data storage device 314 such as a magnetic disk or optical disk, coupled to bus 316 for storing information and instructions. Computer system 300 may be coupled via input/output module 318 to various devices. The input/output module 318 can be any input/output module. Exemplary input/output modules 318 include data ports such as USB ports. The input/output module 318 is configured to connect to a communications module 320. Exemplary communications modules 320 include networking interface cards, such as Ethernet cards and modems. In certain aspects, the input/output module 320 is configured to connect to a plurality of devices, such as an input device 322 and/or an output device 324. Exemplary input devices 322 include a keyboard and a pointing device, e.g., a mouse or a trackball, by which a user can provide input to the computer system 300. Other kinds of input devices 322 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 324 include display devices such as a LCD (liquid crystal display) monitor, for displaying information to the user.

According to one aspect of the present disclosure, the above-described systems can be implemented using a computer system 300 in response to processor 310 executing one or more sequences of one or more instructions contained in memory 312. Such instructions may be read into memory 312 from another machine-readable medium, such as data storage device 314. Execution of the sequences of instructions contained in the main memory 312 causes processor 310 to perform the process steps described herein. One or more processors in a multi-processing arrangement may also be employed to execute the sequences of instructions contained in memory 312. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 300 can include clients and servers. A client and server are generally remote from each other and typically interact through a communication network. The relationship of client and server arises by virtue of computer programs running on the respective computers and having a client-server relationship to each other. Computer system 300 can be, for example, and without limitation, a desktop computer, laptop computer, or tablet computer. Computer system 300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 310 for execution. Such a medium may take many forms, including, but not limited to, non-volatile media, volatile media, and transmission media. Non-volatile media include, for example, optical or magnetic disks, such as data storage device 314. Volatile media include dynamic memory, such as memory 312. Transmission media include coaxial cables, copper wire, and fiber optics, including the wires that comprise bus 316. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 300 reads data, information may be read from the data and stored in a memory device, such as the memory 312. Additionally, data from the memory 312 servers accessed via a network the bus 316, or the data storage device 314 may be read and loaded into the memory 312. Although data is described as being found in the memory 312, it will be understood that data does not have to be stored in the memory 312 and may be stored in other memory accessible to the processor 310 or distributed among several media, such as the data storage 314.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the disclosure. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the disclosure.

What is claimed is:

1. A computer-implemented method for protecting real-time audio/visual (A/V) communications, the method comprising:
capturing, at a sensor of a first A/V communication device, A/V data;
transmitting the captured A/V data to a secure hardware module of a System on a Chip (SoC) associated with the first A/V communication device, the secure hardware module having a first trusted execution environment that is inaccessible by an Operating System of the SoC associated with the first A/V communication device;
encrypting, in the first trusted execution environment, the captured data;
transmitting the encrypted data from the first A/V communication device to a second A/V communication device;
receiving, at a secure hardware module of a SoC associated with the second A/V communication device, the encrypted data, the secure hardware module of the SoC associated with the second A/V communication device having a second trusted execution environment that is inaccessible by an Operating System of the SoC associated with the second A/V communication device;
decrypting, in the second trusted execution environment, the encrypted data; and
causing presentation of the decrypted data at the second A/V communication device.

2. The method of claim 1, wherein encrypting the captured data in the first trusted execution environment comprises encrypting the captured data with a session key.

3. The method of claim 2, further comprising periodically changing the session key in accordance with a pre-determined time interval.

4. The method of claim 3, wherein the pre-determined time interval is between one and ten seconds.

5. The method of claim 1, further comprising designating a privilege level of at least a portion of a plurality of hardware modules of the SoC associated with the first A/V device as one of secure or non-secure.

6. The method of claim 1, further comprising designating a privilege level of at least a portion of a plurality of hardware modules of the SoC associated with the second A/V device as one of secure or non-secure.

7. The method of claim 1, wherein the A/V data includes one or more of audio data, image data, and video data.

8. A system configured for protecting real-time audio/visual (A/V) communications, the system comprising:
one or more hardware processors configured by machine-readable instructions to:
capture, at a sensor of a first A/V communication device, A/V data;
transmit the captured A/V data to a secure hardware module of a System-on-a-Chip (SoC) associated with the first A/V communication device, the secure hardware module having a first trusted execution environment that is inaccessible by an Operating System of the SoC associated with the first A/V communication device;
encrypt, in the first trusted execution environment, the captured data using a session key;
transmit the encrypted data from the first A/V communication device to a second A/V communication device;
receive, at a secure hardware module of a SoC associated with the second A/V communication device, the encrypted data, the secure hardware module of the SoC associated with the second A/V communication device having a second trusted execution environment that is inaccessible by an Operating System of the SoC associated with the second A/V communication device;
decrypt, in the second trusted execution environment, the encrypted data; and
cause presentation of the decrypted data at the second A/V communication device.

9. The system of claim 8, wherein the one or more hardware processors further are configured by the machine-readable instructions to periodically change the session key in accordance with a pre-determined time interval.

10. The system of claim 9, wherein the pre-determined time interval is between one and ten seconds.

11. The system of claim 8, wherein the one or more hardware processors further are configured by the machine-readable instructions to designate a privilege level of at least a portion of a plurality of hardware modules of the SoC associated with the first A/V device as one of secure or non-secure.

12. The system of claim 8, wherein the one or more hardware processors further are configured by the machine-readable instructions to designate a privilege level of at least a portion of a plurality of hardware modules of the SoC associated with the second A/V device as one of secure or non-secure.

13. The system of claim 8, wherein the A/V data includes one or more of audio data, image data, and video data.

14. A non-transient computer-readable storage medium having instructions embodied thereon, the instructions being executable by one or more processors to perform a method for protecting audio/visual (A/V) communications, the method comprising:
capturing, at a sensor of a first A/V communication device, real-time A/V data;
transmitting the captured real-time A/V data to a secure hardware module of a System-on-a-Chip (SoC) associated with the first A/V communication device, the secure hardware module having a first trusted execution environment that is inaccessible by an Operating System of the SoC associated with the first A/V communication device;
encrypting, in the first trusted execution environment, the captured real-time A/V data;
transmitting the encrypted data from the first A/V communication device to a second A/V communication device;
receiving, at a secure hardware module of a SoC associated with the second A/V communication device, the encrypted data, the secure hardware module of the SoC associated with the second A/V communication device having a second trusted execution environment that is inaccessible by an Operating System of the SoC associated with the second A/V communication device;
decrypting, in the second trusted execution environment, the encrypted data; and
causing presentation of the decrypted data at the second A/V communication device.

15. The computer-storage medium of claim 14, wherein encrypting the captured data in the first trusted execution environment comprises encrypting the captured data with a session key.

16. The computer-storage medium of claim 15, further comprising periodically changing the session key in accordance with a pre-determined time interval.

17. The computer-storage medium of claim 16, wherein the pre-determined time interval is between one and ten seconds.

18. The computer-storage medium of claim 14, wherein the method further comprises designating a privilege level of at least a portion of a plurality of hardware modules of the SoC associated with the first A/V device as one of secure or non-secure.

19. The computer-storage medium of claim 14, further comprising designating a privilege level of at least a portion of a plurality of hardware modules of the SoC associated with the second A/V device as one of secure or non-secure.

20. The computer-storage medium of claim 14, wherein the real-time A/V data includes one or more of audio data, image data, and video data.
